(19) United States
(12) Patent Application Publication
(10) Pub. No.: US 2010/0171057 A1
(43) Pub. Date: Jul. 8, 2010

(54) SHUT-OFF VALVE ASSEMBLY

(76) Inventor: Howard Lowe, Queensland (AU)

Correspondence Address: HOFFMAN WASSON & GITLER, P.C;CRYSTAL CENTER 2, SUITE 522, 2461 SOUTH CLARK STREET, ARLINGTON, VA, 22202-3843, US

(21) Appl. No.: 12/452,650

(22) PCT Filed: Jul. 17, 2008
(86) PCT No.: PCT/AU2008/001039

§ 371 Date: Jan. 13, 2010

(30) Foreign Application Priority Data
Jul. 18, 2007 (AU) 2007903886

(51) Int. Cl. F16K 31/02

(52) U.S. Cl. 251/129.15

(57) ABSTRACT

A shut-off valve assembly (1) comprising: a body (2) having a chamber (20) with an inlet (21) and outlet (22) for fluid; a valve seat (3); a baffle housing (4); and a valve member (10) having a sealing member (101) for sealing the valve seat (3) and a piston (102) extending from the sealing member (101). The sealing member (101) is movable between a shielded position, whereby the sealing member (101) seals the baffle housing (4) in a fluid-tight manner and an unshielded position whereby the sealing member (101) does not seal the baffle housing (4) and is movable by the fluid stream against the valve seat (3), and a drive comprising a first solenoid (11) that, when energised, moves the sealing member (101) from the shielded position, and a second solenoid (12) that, when energised, moves the sealing member (101) from the valve seat (3).

### TECHNICAL FIELD

This invention relates to a shut-off valve assembly for controlling the flow of fluid through or from a tap or pipe or other type of fluid line.

### BACKGROUND ART

The applicant's earlier U.S. Pat. No. 7,174,912, describes a shut-off valve assembly for controlling the flow of fluid through or from a tap or pipe or other type of fluid line. The assembly includes a body attachable to or within the fluid line and the body has a chamber with an inlet and an outlet for fluid from the fluid line. A valve seat of the assembly provides the outlet. The assembly also includes a baffle arrangement comprising a baffle housing located within the chamber, a valve member and a drive. The valve member has having a sealing member movable between a shielded position, whereby the sealing member seals an interior of the baffle housing in a fluid-tight manner and is substantially shielded by the baffle housing from a fluid stream moving from the inlet to said outlet and in which position the sealing member is not movable by the fluid stream against the valve seat, and an unshielded position whereby the sealing member does not seal the interior of the baffle housing and is movable by the fluid stream against the valve seat to seal the outlet. The valve member has a piston extending from the sealing member, and the drive is operatively connected to the piston and moves the sealing member between the shielded and unshielded positions.

In one embodiment of the shut-off valve assembly as described in U.S. Pat. No. 7,174,912, the drive comprises a pair of solenoids having a piston pivotally connected to the piston of the sealing member. Movement of the piston by one of the solenoids causes the sealing member to move from the shielded position to the unshielded position and movement of the piston by the other solenoid causes the sealing member to return to the shielded position.

In another embodiment of the assembly as described in U.S. Pat. No. 7,174,912, the drive comprises a solenoid connected to an upper region of the piston of the sealing member and one or more springs connected to the piston and located within the baffle housing. The solenoid moves the sealing member from the shielded position and the spring returns the sealing member from the valve seat to the shielded position.

Described herein is an improvement to the shut-off valve assembly described in the applicant's earlier US patent, for controlling the flow of fluid through or from a tap or pipe or other type of fluid line.

### SUMMARY OF THE INVENTION

According to the present invention, there is provided a shut-off valve assembly for controlling the flow of fluid through or from a fluid line, said assembly comprising:

a body attachable to or within a fluid line and having a chamber therein with at least one inlet and outlet for fluid from the fluid line;

a valve seat located within the chamber downstream of the inlet;

a baffle arrangement comprising a baffle housing located within the chamber between the inlet and the valve seat;

a valve member comprising a sealing member for sealing the valve seat and a piston extending from the sealing member, wherein the sealing member is movable between a shielded position, whereby the sealing member seals an interior of the baffle housing in a fluid-tight manner and is substantially shielded by the baffle housing from a fluid stream moving from said inlet to said valve seat and in which position the sealing member is not movable by the fluid stream against the valve seat, and an unshielded position whereby the sealing member does not seal the interior of the baffle housing and is movable by the fluid stream against the valve seat to seal the valve seat; and

a drive comprising a first solenoid having a core connected to the piston that, when energised, moves the sealing member from the shielded position towards the valve seat, and a second solenoid having a core connected to the piston that, when energised, moves the sealing member from the valve seat to the shielded position.

The body can be attached to or within the fluid line (eg. tap or pipe) by any suitable means known to persons skilled in the art. If the body is to be attached to an end of a threaded tap then the body can, for example, have a like threaded end. Alternatively, the assembly can have a hydraulic coupling for quick and easy attachment of the body to a variety of unthreaded taps. Such couplings are well known in the art. The body can have opposing threaded ends for attachment between adjacent pipes.

If the body is to be fitted within the fluid line itself, then the body can, for instance, have an outer threaded surface for attachment to a like-threaded inner surface of a pipe. Alternatively, the body can friction fit within a part of the fluid line, such as within an interior compartment of a pipe or tap.

The body can be of any suitable shape and size. The body can comprise two or more connecting pieces. Preferably, the body has a cylindrical sidewall and an attachable end cap, and the end cap has the inlet. The end cap can provide ready access to the valve member etc. for maintenance or replacement. If the body is to be attached to an end of a threaded tap, then the end cap can have a threaded spout and the inlet can be located at the end of the spout.

In one embodiment of the invention, the valve seat can provide the outlet. In a preferred embodiment, the valve seat extends across the chamber between the inlet and the outlet.

The baffle arrangement can comprise any suitable number and arrangement of baffle walls. The baffle housing can be of any suitable size, shape and configuration. The baffle housing together with the body can define at least one passage through which fluid can flow to the valve seat. The baffle housing can have a top wall and at least one sidewall, and the sidewall can extend from the top wall towards the valve seat. The inventor has found that the assembly works best if the sealing member seals the baffle housing in a fluid-tight manner when in the shielded position.

The assembly can, if necessary, have flow restrictors for slowing the flow of fluid from the inlet to the outlet. Any suitable type of flow restrictor can be used. Preferably, the baffle arrangement comprises additional walls for slowing the flow of fluid. More preferably, perforated walls extend between the baffle housing and the body to slow fluid flow.

The valve member can be of any suitable shape and size. The sealing member can, for instance, be planar. The sealing member can be disk-shaped, it can have a support disk and it can have a rubber surface facing the valve seat. The rubber surface can be provided by, for instance, a disk of neoprene or like material, or a teflon O-ring. An opposing surface of the support disk can be dome-shaped.

The piston extending from the sealing member is preferably rod-shaped.

The sealing member, when in the shielded position, can seal the baffle housing in any suitable way. A peripheral region and/or other region of the sealing member can contact and seal the baffle housing. The point of contact can be within the baffle housing or external of the baffle housing. For instance, a sealing element (e.g. an O-ring) can extend about a periphery of the support disk and engage a sidewall of the baffle housing. The periphery of the support disk can have a groove within which extends an O-ring.

The valve seat can be of any suitable shape and size. The valve seat can have a rubber surface facing the sealing member. The rubber surface can be provided by, for instance, a layer of neoprene or like material, or an O-ring. The valve seat can have a central aperture that is sealed by the sealing member. Alternatively, the valve seat can have a plurality of apertures spaced about the valve seat. The apertures can be annually spaced about the valve seat. The valve seat can have an annual groove for receiving an O-ring of the sealing member, and one or more apertures can be located within the groove.

An outer periphery of the valve seat can be threaded and can be attached to a like threaded region of the body, or between like threaded regions of the body. Alternatively, the valve seat can be integrally formed with a part of the body.

The first and second solenoids may be of any suitable type. The core of each solenoid may extend over the piston of the sealing member and a magnetic coil of each solenoid may be wound about each core. Preferably, the core of the first solenoid is connected to one end of the piston and the core of the second solenoid is connected to the other end of the piston. More preferably, the first solenoid is located upstream of the valve seat, the second solenoid is located downstream of the valve seat and the piston extends through the central aperture of the valve seat. Each solenoid can have a hermetically sealed casing. Each solenoid can be powered by any suitable power source, whether it is a mains supply, a battery, A.C. or D.C.

The assembly can have at least one piston guide located within the chamber for guiding the movement of the piston. The piston guide can comprise a sleeve containing a bush, such as a nylon bush, and the piston can extend through the sleeve.

The assembly can have a pressure relief valve for venting fluid from the chamber after the sealing member has sealed the valve seat. Any suitable type of pressure relief valve can be used. Suitable pressure relief valves are described, for instance, in the applicant's earlier U.S. Pat. No. 7,174,912.

Components of the assembly can be made of brass, steel, ceramics, rubber or plastics material, or any other suitable type of material.

The fluid stream can consist of liquid, gas or a mixture thereof, and in some instances particulate matter that has fluid movement. Preferably, the assembly is used to stop the flow of fluid within a fluid line, such as the flow of water or oil through a pipeline. The assembly can be modified, upsized or downsized for any suitable application.

The shut-off valve assembly can comprise a control mechanism for automatically operating the drive. Preferably, the control mechanism includes a sensor that detects, for example, pressure loss downstream of the valve seat. The sensor can be electrically coupled to the first solenoid, so as to energise the first solenoid and cause the sealing member to move from the shielded position.

The control mechanism can comprise, for example, a battery that provides power to the solenoids for a predetermined period of time, a timer that shuts off power to the solenoids after a predetermined period of time, and/or signal transmitting/broadcasting and receiving units for operating the solenoids from a remote location.

In yet another embodiment of the invention, the control mechanism can comprise signal (eg. radio, microwave, infrared) transmitting/broadcasting and receiving units for operating the solenoids from a distance, even by satellite.

The control mechanism can comprise any combination of the above or any other suitable mechanism known to persons skilled in the art.

The term “comprise”, or variations of the term such as “comprises” or “comprising”, are used herein to denote the inclusion of a stated integer or stated integers but not to exclude any other integer or any other integers, unless in the context or usage an exclusive interpretation of the term is required.

### BRIEF DESCRIPTION OF THE DRAWINGS

A preferred embodiment of the invention will now be described by way of example with reference to the accompanying drawings in which:

FIG. 1 is a cross sectional view of a shut-off valve assembly, in an open condition, for use within a fluid line, according to an embodiment of the invention;

FIG. 2 is a cross sectional view of the shut-off valve assembly of FIG. 1 but in a partly closed condition; and

FIG. 3 is a cross sectional view of the shut-off valve assembly of FIG. 1 but in a fully closed condition.

### BEST MODE OF CARRYING OUT THE INVENTION

In all of the drawings, like reference numerals refer to like features.

The figures show a shut-off valve assembly 1 for restricting the flow of fluid through a fluid line, such as oil through a pipeline.

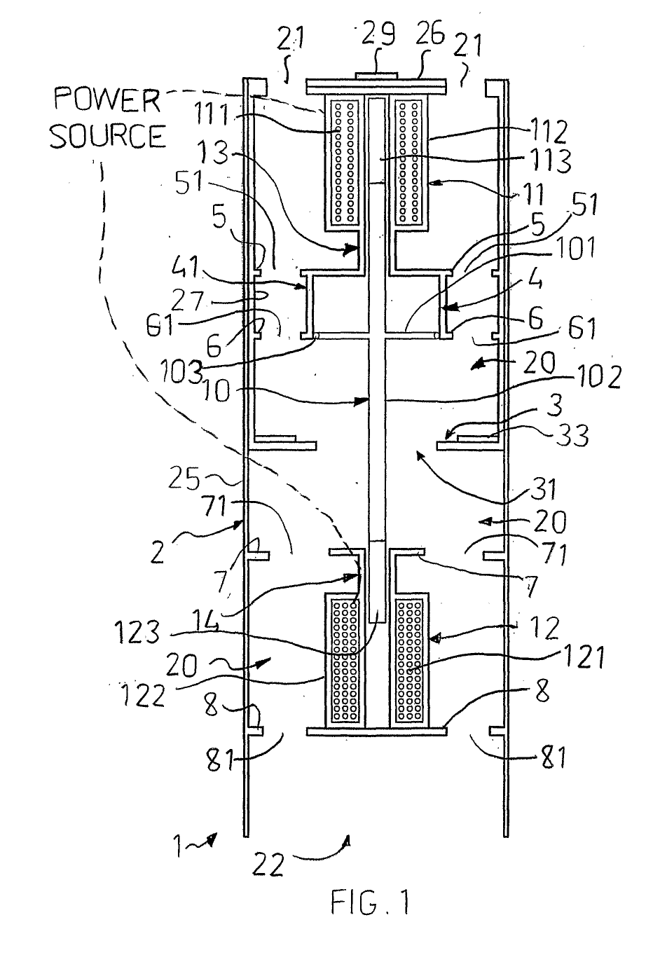

Referring first to FIG. 1, assembly 1 comprises a body 2, a valve seat 3, a baffle arrangement 4-8, a valve member 10, a first solenoid 11, a second solenoid 12, a first piston guide 13, and a second piston guide 14.

The body 2 fits within the fluid line. This may be achieved by having an external part of the body 2 threaded or by fitting the body 2 within a compartment of the fluid line. The body 2 has a chamber 20 with inlets 21 and an outlet 22 for fluid from the fluid line. The body 2 has a cylindrical sidewall 25, an upper region of which is threaded internally. An externally threaded cylindrical piece 27 of the body 2 fits within the upper region of the cylindrical sidewall 25. An end cap 26 of the body 2 is detachable from the cylindrical piece 27. The end cap 26 has a plurality of apertures that provide the inlets 21 and a hexagonal head 29 that can be engaged by a tool when attaching or detaching the end cap 26 from the cylindrical piece 27. The body 2 comprises brass or plastics material.

The valve seat 3 has a central aperture 31. The valve seat 3 is made of brass or plastics material and has a surface layer of neoprene 33. The valve seat 3 extends from a lower end of the cylindrical piece 27.

The valve member 10 comprises a sealing member 101 and a piston 102. The sealing member 101 comprises a brass or plastic support disk and has a surface layer of neoprene (not labelled). The neoprene layer faces the neoprene layer 33 of the valve seat 3. An O-ring 103 extends within a circumferential groove of the sealing member 101. The piston 102 extends from each side of the sealing member 101 and through the aperture 31 of the valve seat 3. The piston 102 comprises non-conductive material, such as plastics material.

The baffle arrangement 4-8 includes four disks 5-8 extending across the chamber 20. Disks 5 and 6 extend from cylindrical piece 27. Disks 7 and 8 extend from cylindrical sidewall 25. Openings 51, 61, 71, 81 in the disks 5-8 allow the flow of fluid from the inlets 21 to the outlet 22. These openings 51, 61, 71, 81 slow the flow of fluid to the outlet 22.

The baffle arrangement 4-8 includes a baffle housing 4 for substantially shielding the sealing member 101 from a fluid stream moving from the inlets 21 to the outlet 22. The baffle housing 4 has a top wall provided by disk 5 and a sidewall 41 extending from disk 5 to disk 6. The O-ring 103 of the sealing member 101 ensures that when the sealing member 101 is in the shielded position, the baffle housing 4 is fluid-tight (i.e. an interior of the baffle housing 4 is sealed). The baffle arrangement 4-8 can comprise brass or plastics material.

The first solenoid 11, when energised, can move the sealing member 101 from the shielded position to an unshielded position whereby it no longer seals the interior of the baffle housing 4. The second solenoid 12, when energised, can return the sealing member 101 to the shielded position.

The first and second solenoids 11, 12 each have a magnetic coil 111, 121 hermitically sealed within a casing 112, 122. An iron core 113, 123 of each solenoid 11, 12 extends over the piston 102 of the valve member 10, such that the piston 102 can be moved by the solenoids 11, 12 when energised. The first solenoid 11 extends from the end cap 26 of the body 2 towards the baffle housing 4. The second solenoid 12 extends from disk 8 towards the valve seat 3. The solenoids 11, 12 are powered by any suitable power source, whether it is a mains supply, a battery, A.C. or D.C. The electrical wiring is not shown.

The assembly 1 has a first piston guide 13 extending between the casing 112 of solenoid 11 and disk 5, for guiding the movement of the piston 102. The piston guide 13 comprises a sleeve containing a nylon bush (not labelled).

The assembly 1 has a second piston guide 14 extending between the casing 122 of solenoid 12 and disk 7. The piston guide 14 comprises a sleeve containing a nylon bush (not labelled).

In use, the assembly 1 is fitted within a fluid line, such as an oil pipeline, and connected to a power source (shown in FIG. 1), such as a battery. The second solenoid 12 is briefly energised so as to move the sealing member 101 to the shielded position whereby it seals the interior of the baffle housing 4. When the assembly 1 is in an open condition, as seen in FIG. 1, fluid can flow through the inlets 21 to the outlet 22 via the central aperture 31 of the valve seat 3. In the open condition and with fluid flowing through the chamber 20, neither solenoid 11, 12 need be energised.

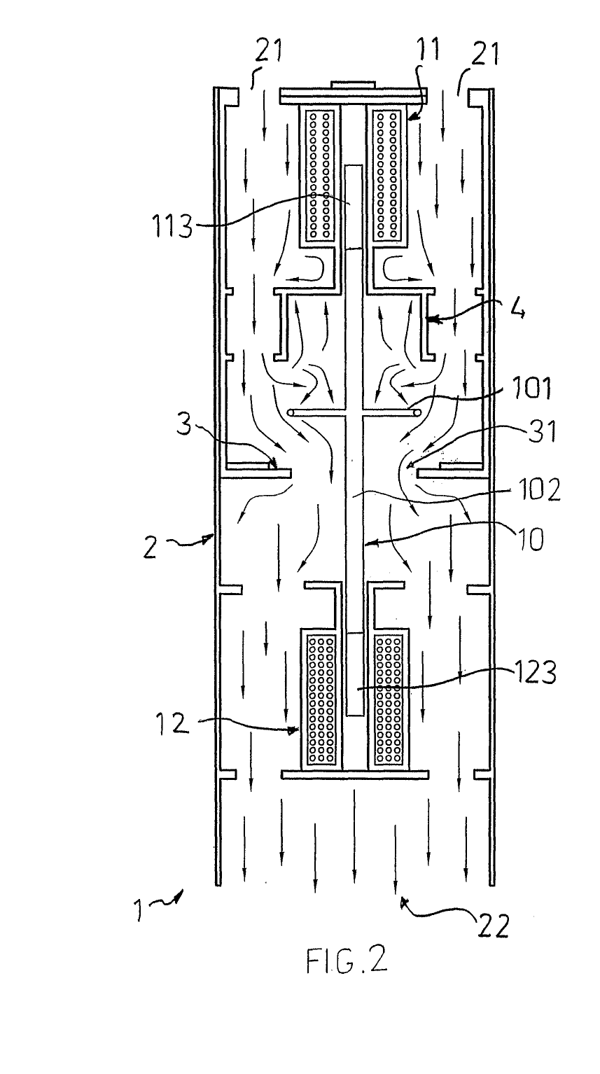

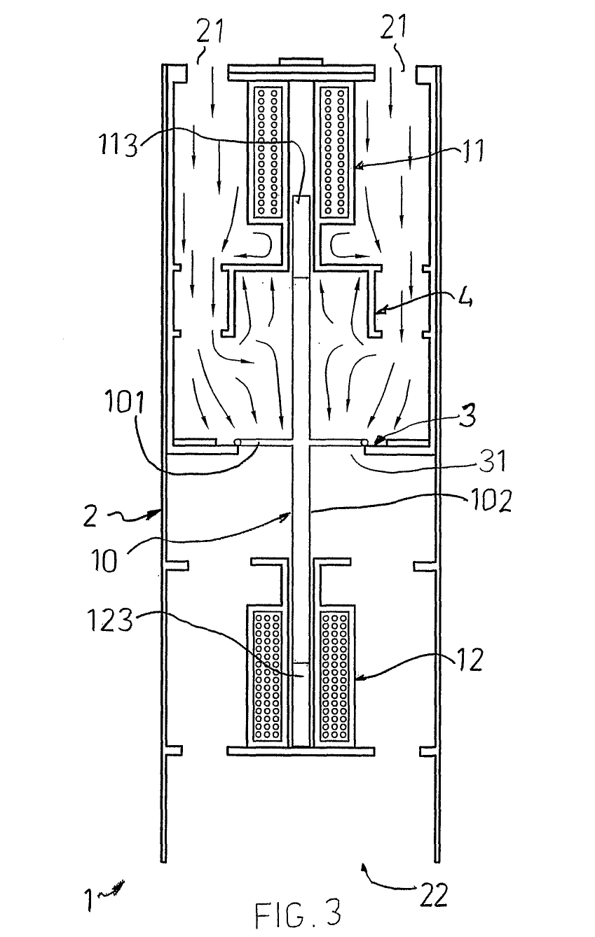

Should there be a need to stop the flow of fluid, such as when there is a leak in the fluid line downstream of the assembly 1, the first solenoid 11 is energised so as to move the sealing member 101 from the shielded position. Upon moving the sealing member 101 from the shielded position, fluid is free to flow between the sealing member 101 and the baffle housing 4 and to enter the baffle housing 4. Such fluid flow is depicted with arrows in FIG. 2. The fluid can then act upon an upper surface of the sealing member 101 and force it against the valve seat 3. The assembly 1, in a closed condition, is seen in FIG. 3. Once in the closed condition, the first solenoid 11 need not be energised.

In order to return the assembly to the open condition, the second solenoid 12 is energised until the sealing member 101 returns to the shielded position, as seen in FIG. 1.

An advantage of the present invention is that a power source is not required to keep the assembly in the open condition or in the closed condition. Another advantage of the present invention is that only a small amount of electrical power is required to move the sealing member against the valve seat and to shut off the flow of fluid. Likewise, only a small amount of electrical power is required to return the assembly to the open condition. Hence, the assembly is of particular use in places having limited power supply, such as pipelines located in remote regions.

Whilst the above has been given by way of illustrative example of the invention, many modifications and variations may be made thereto by persons skilled in the art without departing from the broad scope and ambit of the invention as herein set forth.

The term “comprise” and variants of the term such as “comprises” or “comprising” are used herein to denote the inclusion of a stated integer or stated integers but not to exclude any other integer or any other integers, unless in the context or usage an exclusive interpretation of the term is required.

Any reference to publications cited in this specification is not an admission that the disclosures constitute common general knowledge in Australia.

1. A shut-off valve assembly for controlling the flow of fluid through or from a fluid line, said assembly comprising:
a body attachable to or within a fluid line and having a chamber therein with at least one inlet and outlet for fluid from the fluid line;
a valve seat located within the chamber downstream of the inlet;
a baffle arrangement comprising a baffle housing located within the chamber between the inlet and the valve seat;
a valve member comprising a sealing member for sealing the valve seat and a piston extending from the sealing member, wherein the sealing member is movable between a shielded position, whereby the sealing member seals an interior of the baffle housing in a fluid-tight manner and is substantially shielded by the baffle housing from a fluid stream moving from said inlet to said valve seat and in which position the sealing member is not movable by the fluid stream against the valve seat, and an unshielded position whereby the sealing member does not seal the interior of the baffle housing and is movable by the fluid stream against the valve seat to seal the valve seat; and
a drive comprising a first solenoid having a core connected to the piston that, when energised, moves the sealing member from the shielded position towards the valve seat, and a second solenoid having a core connected to the piston that, when energised, moves the sealing member from the valve seat to the shielded position.

2. The shut-off valve assembly of claim 1, wherein the valve seat extends across the chamber between the inlet and the outlet.

3. The shut-off valve assembly of claim 1, wherein the valve seat has a central aperture that is sealable by the sealing member and the piston extends through the central aperture.

4. The shut-off valve assembly of claim 1, wherein the baffle housing comprises a top wall and a sidewall, and the sidewall extends from the top wall towards the valve seat.

5. The shut-off valve assembly of claim 1, wherein the assembly further comprises flow restrictors for slowing the flow of fluid from the inlet to the outlet.

6. The shut-off valve assembly of claim 1, wherein the sealing member is disk-shaped and the piston extends from each side thereof.

7. The shut-off valve assembly of claim 1, wherein the first solenoid is located upstream of the valve seat and the second solenoid is located downstream of the valve seat.

8. The shut-off valve assembly of claim 1, wherein the core of each said solenoid extends over the piston and a magnetic coil of each said solenoid is wound about each said core.

9. The shut-off valve assembly of claim 8, wherein the cores are connected to the ends of the piston.

10. The shut-off valve assembly of claim 1, wherein the assembly comprises a first piston guide extending between the first solenoid and the baffle housing, and a second piston guide extending from the second solenoid towards the valve seat.

11. The shut-off valve assembly of claim 1, wherein the assembly further comprises a power source for energising the first and second solenoids.
